(19) United States
(12) Patent Application Publication
(10) Pub. No.: US 2009/0000205 A1
(43) Pub. Date: Jan. 1, 2009

(54) Reinforced Sealing, Trimming or Guiding Strips

(75) Inventors: Robert Granville Bright, Viersen Neuwerker (DE); Roger Adrien Boutin, Ridgeway (CA)

Correspondence Address: BINGHAM MCCUTCHEN LLP, Three Embarcadero Center, San Francisco, CA, 94111-4067, US

(73) Assignee: GDX North America Inc., Dover, DE (US)

(21) Appl. No.: 11/817,349

(22) PCT Filed: Mar. 3, 2006
(86) PCT No.: PCT/IB2006/000548

§ 371 Date: Sep. 17, 2008

(30) Foreign Application Priority Data
Mar. 3, 2005 (GB) 0504481.3
Apr. 6, 2005 (GB) 0506991.9

(51) Int. Cl. E06B 7/16; B60J 10/00

(52) U.S. Cl. 49/489.1; 49/475.1; 49/506

(57) ABSTRACT

A join-free sealing strip 1 is disclosed for fitting to the window frame (1) of a vehicle door (5). This sealing strip has embedded therein a slotted carrier. The carrier is stretch bent (or otherwise treated) at regions L5M where there is a sharp corner to increase the rigidity of the strip (1) in these regions. At a position (O) between these regions the carrier is arranged to be relatively less rigid and to be relatively easily extendible and/or compressible. The strip (1) can be simply fitted to the door frame (3) due to the rigid sharp corner regions L5M. The relatively less rigid region (O) between the corner regions allows variations in the dimensions between different door frames (3) to be accommodated. A procedure for avoiding indentations in the flexible material of the strip (1) being visible at positions corresponding to the locations of the slots in the carrier (i.e. avoiding carrier read-through) is also disclosed. A method and apparatus for selectively forming slits in the carrier is also disclosed.

### TECHNICAL FIELD

The present invention relates to sealing, trimming or guiding strips having reinforcements, particularly to such strips comprising flexible material and having a reinforcing member at least partially embedded in the flexible material. The strip may, for example, be for sealing around and supporting a window pane in the window frame of a vehicle door and/or for sealing between the door opening in a vehicle body and the door. The invention also relates to methods and apparatus for producing reinforcements for flexible strips. However, reinforcements made in accordance with the methods or apparatus of the invention may be used in other applications.

### BACKGROUND TO THE INVENTION

The use of sealing, trimming or guiding strips formed of flexible material is known for sealing around movable window panes mounted in door frames of vehicle doors and for sealing between the frame of a door and the door opening in a vehicle body. It is known to embed within the flexible material of such strips reinforcing members or “carriers”. Typically such reinforcing members for carriers are embedded within the part of the strip that forms a channel for grippingly receiving a flange of the door frame or vehicle body. The presence of the reinforcing member or carrier in the channel tends to securely locate the strip with respect to the flange of the frame or body.

One known type of carrier is described in EP-A-0473283 (“SR Carrier”, GDX-6340). The strip disclosed in this publication has a carrier embedded within the base and side walls of a flange-receiving channel. The carrier has a plurality of slots formed therein which allow bending of the flexible strip. Bending of the flexible strip incorporating the carrier causes a certain amount of strain to develop in the carrier between its opposite side walls, and this gives a degree of semi-rigidity to the carrier. The rigidity of the carrier is not sufficient to make it easy to properly locate the strip in a sharp corner of the window frame. Further, the rigidity of the strip may not be sufficient to make it easy to handle when installing the strip to the window frame.

To overcome such problems it has been proposed to form sealing, trimming or guiding strips with a solid aluminium reinforcing member or carrier embedded within flexible material. However, such strips, due to the solid aluminium member, cannot accommodate vehicle, manufacturing or assembly build variations—i.e. differences in dimensions between different door frames. Further, such strips are expensive to manufacture.

### SUMMARY OF THE INVENTION

According to a first aspect of the present invention, there is provided a sealing, trimming or guiding strip for sealing around an opening in a frame, the strip comprising flexible material and having a reinforcing member at least partially embedded in the flexible material, the member having a series of apertures formed therein and being arranged such that the rigidity of the member can be selectively varied at respective parts of the strip.

According to a second aspect of the present invention, there is provided a method of forming a sealing, trimming or guiding strip for sealing around an opening in a frame, the method including at least partially embedding a reinforcing member within flexible material forming the strip, the reinforcing member having a series of apertures formed therein, the member being arranged such that the rigidity of the member can be selectively varied at respective parts of the strip.

According to a third aspect of the present invention, there is provided apparatus for producing a longitudinally extending reinforcement for a flexible strip, comprising a pair of rotary processing members arranged to have a bight between them, means defining a working path passing through the bight, and means for feeding a longitudinally extending blank along the path, at least a first one of the rotary members being provided with cutter means arranged around a first portion, only, of its circumference and in alignment with the said path so as to carry out cutting operations on the blank as it passes through the bight in engagement with those cutter means, there being no cutter means on the second, remaining, portion of the circumference of the first rotary member and no cutter means on a corresponding second portion of the circumference of the second rotary member, so that no cutting operations are carried out on the blank by the said second portions of the circumference of the rotary members.

According to a fourth aspect of the present invention, there is provided apparatus for producing a longitudinally extending metal carrier for a sealing, trimming or guiding strip, the carrier having longitudinally extending relatively flexible regions provided with slots therethrough and separated by longitudinally extending relatively rigid and unslotted regions, comprising: means defining a longitudinally extending working path; feeding means for feeding a longitudinally extending metal blank along the working path which has the same width as the working path; a pair of rotary cutters rotating in opposite directions in contact with each other about parallel axes extending widthwise across the said path and so that the working path passes through the bight between the two rotary cutters; the rotary cutters each having a width measured in the axial direction which is greater than the width of the said path; each rotary cutter having a first surface portion extending around part, only, of the circumference of the cutter and carrying cutter blades extending axially of the cutter and spaced apart from each other over the peripheral extent of the first portion and each cutter extending across part, only, of the width of the working path, whereby the cutter blades cut slits through the metal blank in the working path as the cutter blades come into engagement with each other at the bight, and a second surface portion extending over the remaining circumferential part of the cutter and which is free of cutter blades so that the blank is not cut when any part of these portions are present at the bight of the cutters; stretching means for stretching the blank so as to convert the slits into slots; and means for forming the blank into channel-form.

According to a fifth aspect of the present invention, there is provided a method of producing a reinforcement which is for incorporation in a flexible strip and which has longitudinally alternating relatively flexible and relatively stiff regions, comprising the steps: of feeding a longitudinal blank along a working path which has the same width as the blank and which passes through the bight of two rotary cutter members which have cutter blades positioned at predetermined intervals spaced from each other around a first surface portion, only, of the circumference of each rotary cutter such that the cutter blades when present at the bight produce cuts through the blank but extending only partway across the width thereof, whereby to produce a said relatively flexible region of the reinforcement; each rotary cutter being free of any cutter blades over a second surface portion corresponding to the remaining circumferential part of the cutter so that no cuts are produced in the blank when the second portions are present at the bight, whereby to produce a said relatively stiff region of the blank; and adjusting the position of the blank in relation to the angular positions of the rotary cutters so as to adjust the length of the said relatively stiff region of the blank.

In the sealing systems field such reinforcing members are commonly referred to as “carriers”.

### BRIEF DESCRIPTION OF THE DRAWINGS

For a better understanding of the invention, embodiments will now be described by way of example, with reference to the accompanying drawings, in which:

FIG. 1 is a perspective view of a sealing strip incorporating a metal carrier;

FIG. 2 is a side view of a closed loop of sealing strip fitted to a door opening of a vehicle body;

FIG. 3 is a perspective view of one form which such a carrier can take;

FIG. 4 shows a plane view of a thin metal blank from which the carrier is produced, shown at a stage during its manufacture;

FIG. 5 is a perspective side view of part of one form of the apparatus in use;

FIG. 6 is a perspective view of part of the apparatus of FIG. 5;

FIG. 7 is an enlarged perspective view of part of the apparatus of FIGS. 5 and 6;

FIG. 8 is a schematic view of the apparatus of FIGS. 5 to 7, showing a control system;

FIG. 9 corresponds to FIG. 5 and shows part of a modified form of the apparatus of FIG. 5;

FIG. 10 corresponds to FIG. 6 and shows part of the modified form of the apparatus;

FIG. 11 corresponds to FIG. 5 and shows part of a further form of the apparatus of FIG. 5;

FIG. 12 corresponds to FIG. 6 and shows another part of the further form of the apparatus;

FIG. 13 shows a perspective view of the inner panel of a vehicle door to which a sealing strip in accordance with an alternative embodiment of the invention is fixed;

FIG. 14 shows a perspective view of the sealing strip of FIG. 13 with the door panel omitted;

FIG. 15 shows a cross-section taken through the sealing strip of FIGS. 13 and 14;

FIG. 16 shows a cut-away perspective view of the sealing strip of FIGS. 13 to 15;

FIG. 17 shows an overhead plan view of the reinforcing member or carrier during a stage of its manufacture prior to embedding the carrier within the sealing strip;

FIG. 18 shows a perspective view of the carrier of FIG. 17 at a later stage in its manufacture; and

FIG. 19 shows the sealing strip prior to fitment thereof to the door of FIG. 13.

### DESCRIPTION OF MODES OF CARRYING OUT THE INVENTION

In the drawings, like elements are generally designated with the same reference sign.

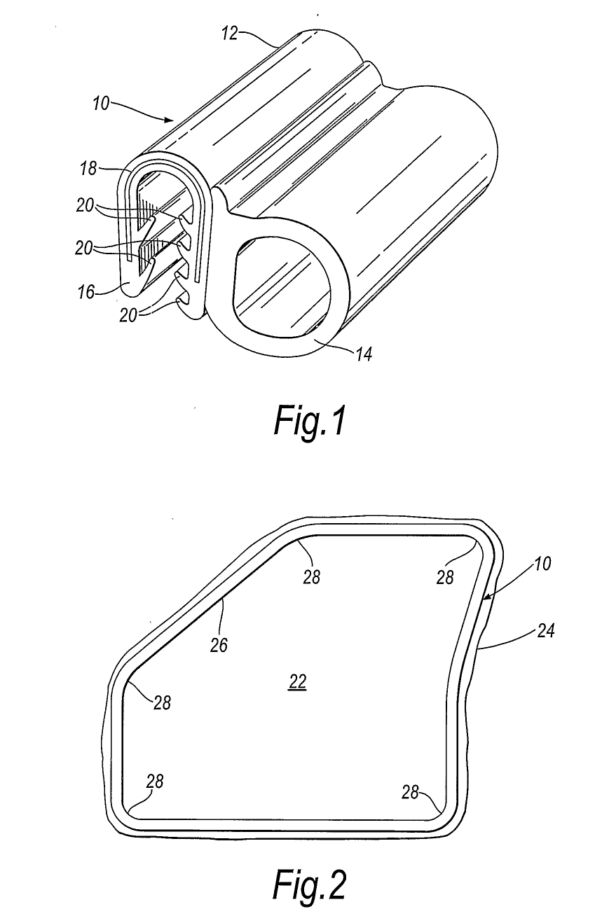

FIG. 1 shows a sealing strip 10 which may be used in motor vehicle body construction. The sealing strip comprises a channel-shaped gripping section 12 and a soft tubular sealing section 14.

The gripping section 12 comprises extruded rubber or plastics material 16 in which is embedded a reinforcing metal carrier 18. The metal carrier 18 is generally U-shaped and may be incorporated into the extruded material 16 using a cross-head extruder.

The extruded material 16 is extruded to provide inwardly directed gripping lips 20.

The tubular sealing section 14 is advantageously made of foamed or sponge rubber. It may be produced separately and then adhesively secured to the gripping section 12. Instead, it can be extruded simultaneously with the material 16.

In use, the sealing strip 10 may be used to provide a weatherproof seal around a door opening in a motor vehicle body. For example, the sealing strip may be mounted around the door opening by means of the gripping section 12, which embracingly grips the flange surrounding the door opening and formed where the inner and outer body panels are welded together at the door opening. The gripping section 12 supports the sealing strip 10 so that the sealing section 14 runs around the door opening and is so positioned as to be contacted by, and partially compressed by, the closing door, thus providing a weather proof seal.

In certain cases, such as where the sealing strip is to be mounted around a luggage compartment opening, the sealing section 14 may be mounted on the outside of the inverted base of the channel of the gripping section instead of along one of its side walls. The sealing section is thus positioned so as to be contacted and partially compressed by the closing lid for the luggage compartment.

The gripping lips 20 help to hold the gripping section 12 firmly on the flange. Advantageously, the gripping lips 20 are extruded (simultaneously with the remainder of the extruded material 16) so as to be softer than the remainder of the material; this is found to increase the gripping force.

The metal carrier 18 provides reinforcement and resilience which helps to hold the gripping section 12 in position on the flange.

FIG. 2 shows a door opening 22 of a vehicle body and the flange 24 to which the sealing strip 10 of FIG. 1 is to be fitted. The sealing strip 10 may be provided in a continuous length, and the fitter then applies it manually, or with the aid of a suitable tool, to the flange 24 and then cuts it off to length. In many cases, however, it may be advantageous for the sealing strip 10 to be provided to the vehicle manufacturer in the form of a pre-formed closed loop 26 as shown in FIG. 2. In this case, advantageously the closed loop 26 of sealing strip is pre-formed with bends or corners 28 which are positioned to match the bends or corners in the flange 24. The closed loop 26 of sealing strip can then be fitted into position on the flange 24 as a single unit, manually, or using a suitable hand tool, or by robot.

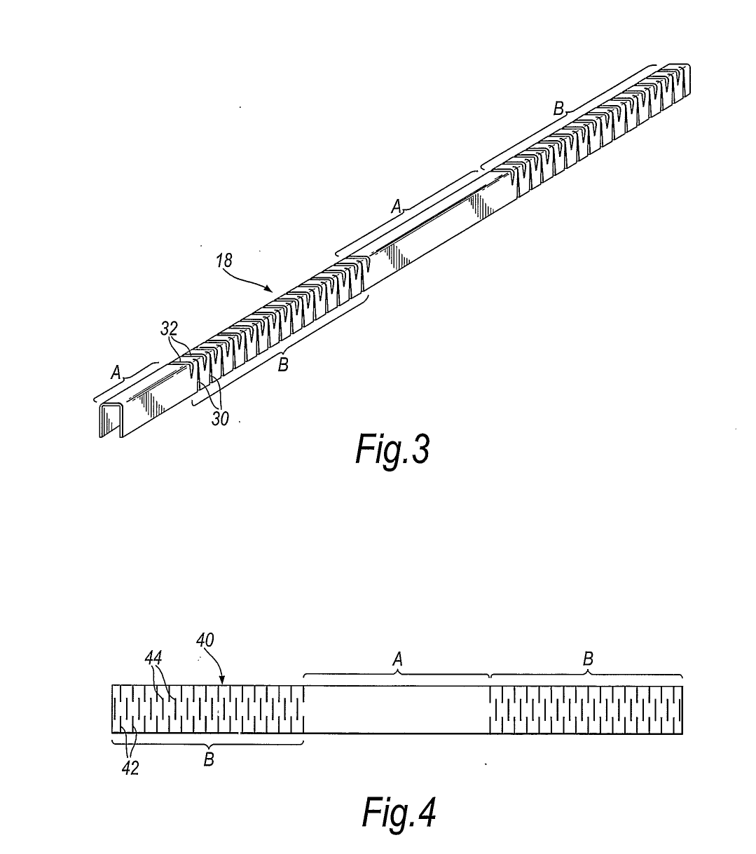

FIG. 3 shows one form which the metal carrier 18 may take. As shown, it is channel-shaped and is provided with slots of two different types 30 and 32. Each slot 30 extends from one of the edges running along the channel mouth to a point in the inverted base of the channel. Each slot 32 extends across the base of the channel and partway into each channel side. The slots 30 and 32 alternate along the length of the channel. Slots 30 are also provided on the opposite side wall of the channel (though are not visible in the Figure). The slots 30 and 32 thus render the carrier relatively flexible.

The slots 30 and 32 are produced, in a manner to be described in more detail below, by metal cutting operations.

As shown in FIG. 3, along parts (regions A) of the length of the carrier, it is devoid of the slots 30 and 32 and thus has the form of a plain metal channel. Over these parts of the carrier, therefore, the carrier is relatively rigid. Thus, in the case where the sealing strip is to take the form of a closed loop 26, as shown in FIG. 2, it may be advantageous for the metal carrier to have the relatively flexible form (regions B in FIG. 3), produced by the slots 30 and 32) at those parts of the length of the carrier corresponding to the bends 28 (FIG. 2), whereas, over those parts of the lengths between the bends 28, it may be advantageous for the metal carrier to be of the plain unslotted form (regions A of FIG. 3). In this way, the strip is sufficiently flexible to be able to accommodate the bends 28 and thus to follow the corresponding bends in the flange 24 (FIG. 2), whereas, over the regions of the sealing strip between the bends 28, it will be relatively stiff. Such a construction may make the sealing strip easier to handle, and is particularly advantageous for robot fitting.

Alternatively, it may be preferred to make the carrier more rigid where the bend 28 are present and less rigid elsewhere. Different patterns of slits can be formed in different areas of the carrier to control the rigidity. There may be no unslitted regions of the carrier.

The methods and apparatus now to be described enable a metal carrier of the form shown in FIG. 3, having relatively flexible, slotted, regions B and plain or unslotted regions A, to be produced.

The metal carrier is produced from a flat metal blank 40 as shown in FIG. 4.

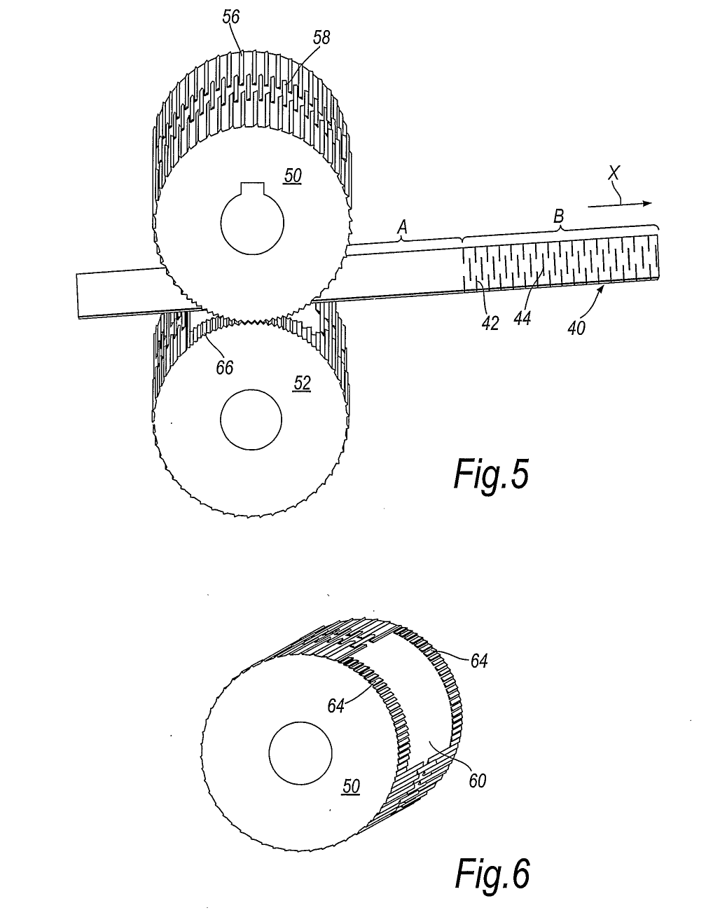

An initial step in the process comprises the cutting of thin slits through the metal of the blank 40. The slits are cut through parts of the blank 40 where the regions B (the slotted regions, see FIG. 4) are to be formed. As shown in FIG. 5, the slits are of two forms. Thus, there are slits 42, each of which extends partway across the width of the blank from a respective one of its marginal edges, and there are slits 44, each of which extends across a central part of the width of the blank. Over the regions of the blank 40 which are to produce the plain or unslotted regions A (see FIG. 3), no slits are formed.

A longitudinal metal stretching process is then carried out on the slit blank 40 which has the effect of expanding the slits into slots, such slots comprising the slots 30 and 32 shown in FIG. 3. Slits 42 produce slots 30 and slits 44 produce slots 32. The blank is also bent into channel form. The stretching process may take the form of passing the blank longitudinally through the bight of two plain rollers which contact one or more paths extending longitudinally along the blank but over part of its width only; for example, there may be two such paths extending along its marginal edges. These rollers compress the metal of the blank along these longitudinal paths so as to thin-down the material, and this has the effect of stretching the blank so as to expand the slits 42,44 into the slots 30,32. Alternatively, under certain circumstances the bending of the slit metal blank into channel-form, after provision of the slits 42,44, may have the effect of expanding the slits into slots.

After the carrier has been produced in this way and bent into channel-form, it can then be passed into a cross-head extruder which, by means of a suitable die, extrudes the material 16 (see FIG. 1) over the carrier.

FIGS. 5,6 and 7 show one way in which the slit blank of FIG. 3 can be produced.

The slits 42,44 are produced by passing the blank 40 through the bight of two rotary cutters 50,52. These rotary cutters are formed with a series of cutter blades 56,58 which are arranged around the major part of the periphery of each of the rotary cutters 50,52. The cutter blades 56,58 on the two rotary cutters inter-engage with each other as the cutters rotate, the cutters being rotated by a suitable motor (not shown). As the blank passes through the bight of the two rotary cutters (in the direction of arrow X), the cutter blades 56,58 cut through the metal of the blank to produce the slits 42 and 44. The cutter blades 56 produce the slits 42, while the cutter blades 58 produce the slits 44.

However, FIGS. 5,6 and 7 show how the rotary cutters are devoid of the cutter blades 56,58 over blank portions 60 and 62 on the rotary cutters 50 and 52 respectively. Over the blank portions 60,62, the central part of the width of each cutter, which is slightly greater in width than the width of the metal blank 40, is smooth, and a series of teeth 64,66 are provided along the outside regions of the width of each of the rotary cutters rotate. The teeth 64,66 have the effect of spacing the blank portions 60,62 from each other by a small distance. Therefore, when the blank portions 60,62 are aligned with each other, at the bight of the two rollers, as shown in FIG. 5, a “tunnel” or gap is formed which is devoid of any teeth 56,58. Thus, no slits 42,44 are cut in the blank 40. An unslit portion of the blank 40 is therefore produced, corresponding to an unslit region A of FIG. 3.

The pitch of the teeth 60,64 may in fact be twice the pitch of the cutters 56,58. For example, the rotary cutters 50,52 may initially be formed with teeth corresponding to the teeth 60,64 which extend across the full width of the surface of each rotary cutter and around the complete periphery. The teeth are then machined away to form the blank regions 60,62 and, over the remainder of the periphery of each rotary cutter, are machined as necessary to convert the teeth into the cutter blades 56,58.

The length of the unslit portion of the blank can be adjusted in a variety of ways.

For example, when the unslit portions 60,62 come together at the bight of the rotary cutters 50,52, the rotation of the two cutters can be stopped. This then enables the blank to be pulled through the “tunnel” to the desired extent according to the length of the unslit region A required. The cutters 50,52 can then be set into rotation again. If a relatively short length of unslit region A is required, this can be achieved by allowing the rotary cutters to continue their rotation as the blank 40 moves through the tunnel at its normal speed. The unslit region A can be made even shorter in length by slowing down or halting longitudinal movement of the blank or perhaps momentarily accelerating the rotational speed of the cutters 50,52.

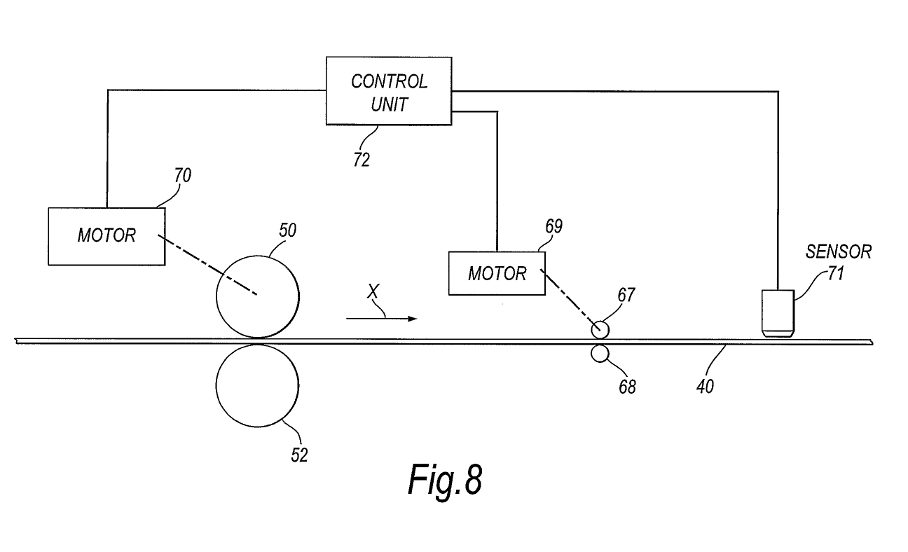

A shown in FIG. 8, for example, the system may employ rollers 67,68 driven by a motor 69 which pull the blank 40 along its path through the bight of the cutters 50,52 which are driven by a motor 70. A sensor 71 serves the instantaneous longitudinal position of the blank 40. A control unit 72, such as a microprocessor, receives signals from the motors 69 and 70, thus sensing the speed of the rollers 67,68 and the cutters 50,52 and the instantaneous angular positions of the latter, and also from the sensor 68. In this way, the control unit can adjust the speeds of the rollers 67,68 and the cutters 50,52 to ensure that the blank is produced with regions A and regions B at the correct longitudinal positions and with the desired lengths.

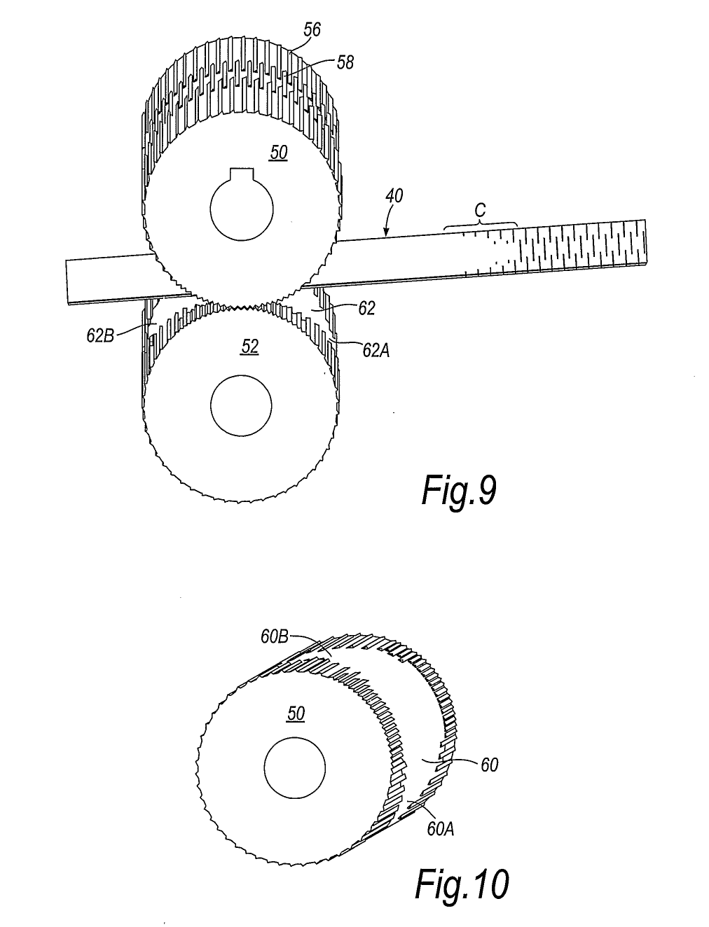

A modified form which the cutters 50,52 can take is shown in FIGS. 9 and 10. In this case, the blank regions 60 and 62 of the rotary cutters 50,52 have tapered and portions 60A,60B and 62A and 62B. The effect of these tapered portions is to modify the lengths of the slits 42,44 which are produced on the blank 40 in the transition between the slit regions B and the unslit regions A. With the form of rotary cutters shown in FIGS. 5,6 and 7, where the slits 42 and 44 have a constant configuration over the slit regions B, there may be a tendency for the blank 40 to bend sharply, or kink, at each junction between a slit region B and an unslit region A. The transition region C (see FIG. 9) produced by the tapered portions 60A,60B and 62A,62B of the modified form of rotary cutters 50 and 52 shown in FIGS. 9 and 10 avoids this problem.

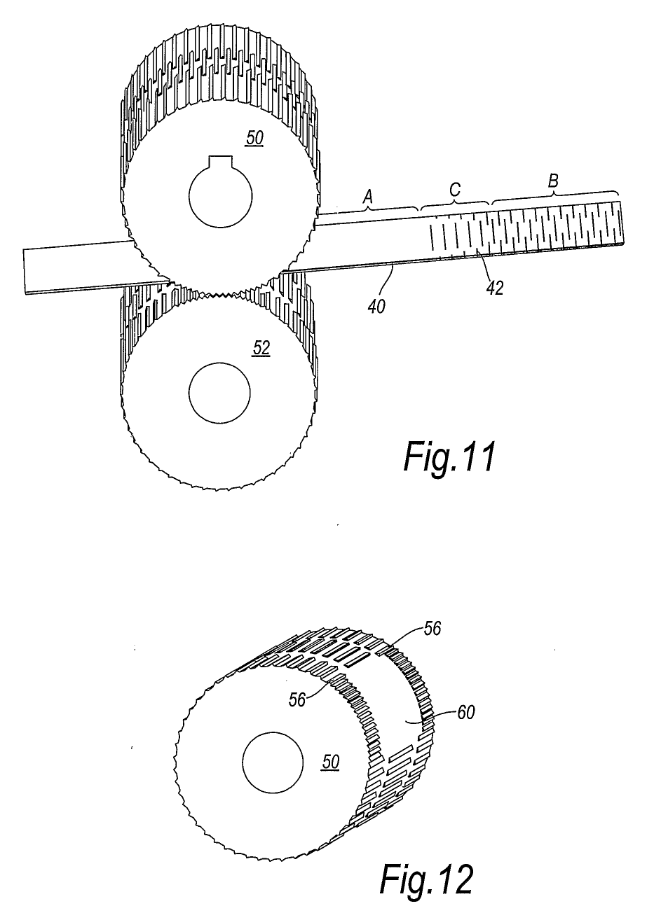

Another way of avoiding the same problem is shown in the modified rotary cutters of FIGS. 11 and 12. In this case, the cutter blades 56 immediately adjacent the ends of the blank portions 60 and 62 have reduced length as compared with their length over the major part of the periphery of each rotary cutter. As shown in FIG. 12, the cutter blades 56 immediately adjacent to the end of the blank portion 60 are very short in length, succeeding ones then gradually increasing in length until they reach the full, normal length. The cutter blades 58 on the cutter 52 are similarly arranged. The effect of this is to produce slits 42 gradually decreasing in length over a transition region C (see FIG. 11) between each slit region B and the next non-slit region A. Again, this transition region C helps to prevent any tendency for the finished blank to bend sharply or kink at the transition.

A second embodiment of the invention will now be described.

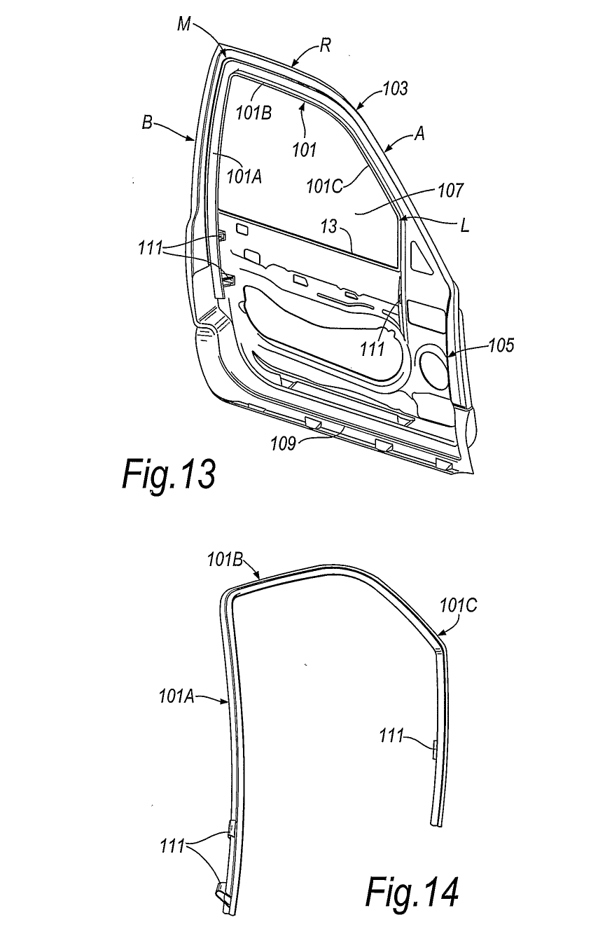

Referring initially to FIGS. 13 and 14, the sealing, trimming or guiding strip 101 of the embodiment is for fitting to the window frame 103 of a vehicle door 105. The window frame 103 defines an aperture 107 that is closed by a window pane. In the conventional manner, the window pane slides upwardly and downwardly within the door. The door 105 illustrated in FIG. 13 is the front passenger door of a vehicle (although the invention is equally applicable to sealing strips for fitting to the rear passenger doors of vehicles or to other structures having a frame). Only the inner panel 109 of the door 105 is shown in FIG. 13. The finished door 105 will also comprise an outer panel fitted over and spot-welded (or attached by other means) to the inner panel 109. The outer panel will be visible from the exterior of the vehicle.

The strip 101 includes a first portion 101A extending along the B-pillar B of the vehicle, a second portion 101B extending along the roofline R of the vehicle, and a third portion 101C extending partly along the A-pillar A of the vehicle. The portion 101C extends along the A-pillar up to point L, whereafter it extends vertically downwards.

The parts of the strip 101A and 101C extend below the opening 107 to guide the window pane when it is lowered into the door 105. The extensions to the parts 101A and 101C may have rigid attachment formations 111 moulded onto them (or formed and fixed thereto by any other suitable means) for locating the extensions with respect to the inner door panel 109.

In addition to the parts 101A, 101B and 101C, a waist seal (not shown) will be provided which extends along the waist line 113 of the door 105. The waist seal may be integrally formed with the strip 101, moulded onto the strip 101 or separate from the strip 101.

At the point L an approximately 45° corner is formed followed by the strip 101 Where the B-pillar B meets the roofline R (at point M) an approximately 90° corner is followed by the seal.

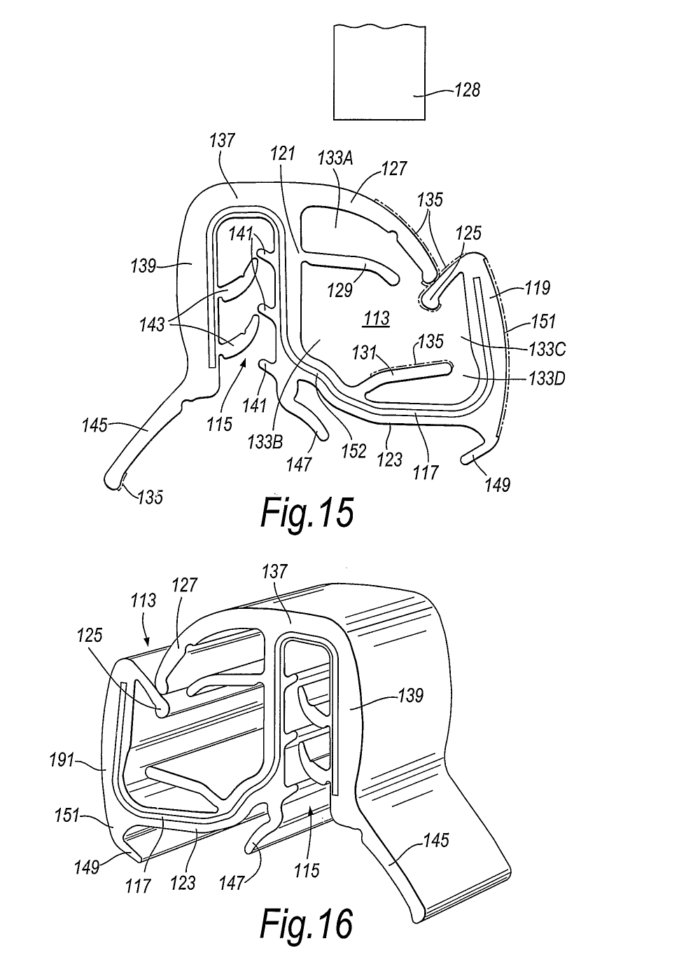

Referring now to FIG. 15 (which is a cross-section taken through any of part 101A,101B or 101C of the strip 101 and to FIG. 16 (which shows a cut-away view of any of the parts 101A,101B or 101C of the strip 101), it can be seen that the strip 101 includes a window receiving channel 113 and a generally oppositely directed flange receiving channel 115. A generally reverse S-shaped reinforcement member or carrier 117 is embedded within the strip 101 and extends around the window receiving channel 113 and the flange receiving channel 115. The carrier 117 is formed of metal or any other suitably rigid material, such as plastics or hard rubber.

The window pane receiving channel 113 has an outer wall 119 and an inner wall 121, which integrally extend from the window pane receiving channel base 123. Extending across the mouth of the channel 113 from the outer wall 119 is a first sealing lip 125. A larger sealing lip 127 extends across the mouth of the channel 123 from the inner wall 121. When the window pane 128 is not present in the window pane receiving channel 113, the lips 125, 127 adopt the position shown. When the window pane 128 enters the window pane receiving channel 113 the sealing lips 125,127 are pushed apart to allow the window pane 128 to pass therebetween, the sealing lips 125 sealing against opposite surfaces of the window pane 128 to provide a moisture and noise resistant seal. A first further lip 129 may extend from the inner wall 121 between the base 123 and the sealing lip 127, and a second further lip 131 may extend approximately from the middle of the base 123. The further lips 129,131 serve to define respective air chambers 133A,133B,133C and 133D within the channel 113, which may reduce the noise level inside the vehicle. The sealing lips 125 and 127 and the further lip 131 may be provided with a low friction coating 135, such as a flocked surface. The coating 135 increases seal durability.

The flange receiving channel 115 is for receiving a flange formed at the periphery of the window frame 103. The flange receiving channel 115 is formed by the inner side wall 121 of the window pane receiving channel 113, a base 137 and a further side wall 139 which extends generally parallel to the side wall 121 (and the outer side wall 119 of the window pane receiving channel 113). A first set of three gripping lips 141 extend from the side wall 121 into the flange receiving channel 115, and a second set of two larger gripping lips 143 extend from the side wall 139 into the channel 115. The gripping lips 141,143 serve to securely locate the sealing strip 101 on the flange of the window frame 103. The presence of the rigid carrier 117 controls the flexing of the side walls 117,121 and 139. This allows the flange to be tightly gripped by the flange receiving channel 115 and for the window pane to be effectively sealed by the sealing lips 125,127.

Further lips 145,147 extend respectively from side walls 121 and 139 from the mouth of the flange receiving channel 115, and a corresponding further lip 149 extends from the side wall 119 of the window pane receiving channel 113 where it meets the base 123 of that channel. The further lip 145 is for pressing against the vehicle body shell when the door 105 is closed. The further lips 147 and 149 are for pressing against elements of the window frame 103.

The components of the strip 101 thus far described (with the exception of the carrier 117) may all be integrally formed with one another. For example, the components may be formed by an extrusion process using an extrusion die. In particular, the low friction or flocked surfaces 135 may be formed during the extrusion process. Advantageously, the carrier 117 is embedded within the strip 101 during the formation of the strip 101 by the extrusion process using the extrusion die. The sealing strip 101 (and the embedded carrier 117) may be cut to suitable lengths as it exits the extrusion die after formation.

The sealing strip 101 may be formed from a thermoplastic vulcanizate (TPV), thermoplastic elastomer (TPE) or ethylene-propylene, diene monomer rubber (EPDM) or any other suitable flexible material. This material is more flexible (less rigid) than the carrier 117.

The outer wall 119 of the strip 101, which is visible from the exterior of the vehicle, may be provided with a surface layer 151 formed of thermoplastic olefin material (TPO). The TPO layer 151 may be moulded onto the strip 101 or attached through a process of fusing several successive layers of material within the extrusion die to create the smooth surface appearance. TPO has a good appearance, is easily moulded (the mould used to form it will require less frequent cleaning than when moulding other materials such as rubber) and can be easily produced in different colours. Therefore, the layer 151 may be given a colour to provide the exterior of the vehicle with the desired visually pleasing appearance. For example, the layer 151 may be coloured matt or gloss black or silver.

In the region where the base 123 of the window pane receiving channel 113 meets the side wall 121 a “Roll Form” feature 152 is provided to allow an independent water management lip function The S-Shape of the carrier as it goes from the vertical to the horizontal direction is added to present independent control and stress relief during the bending of the corners in order to maintain the glass receiving portion 113 of the seal in it's proper location.

The parts 101A,101B and 101C of the strip 101 are all integrally formed by the extrusion process. There are therefore no joins between the parts 101A,101B and 101C, providing the strip 101 with a visually pleasing appearance.

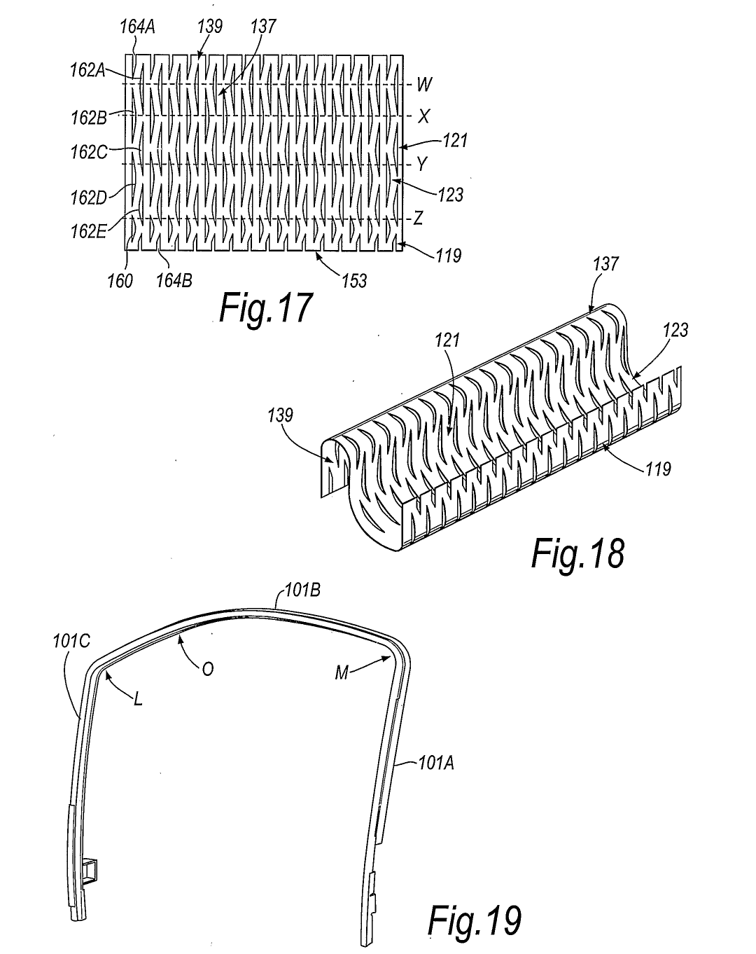

FIG. 17 shows a planar sheet 153 of metal (or other suitable rigid material) from which the carrier 117 is formed. The sheet 153 of material has a multiplicity of slots or apertures formed therein. The slots have a generally triangular form—that is, the slots are widest at their center and tapered toward opposite ends thereof. After formation of the slots or apertures, the sheet 153 is bent along lines W,X,Y and Z in order to form the reverse S-shape of the carrier 117 as shown in FIG. 18 and in order to provide the window pane receiving channel 113 and the flange receiving channel 115. With the exception of the shorter slots 160 formed in the outer side wall 119 of the glass receiving channel 113, all the other slots 162 A . . . E are of the same longer configuration with the exception of edge slots 164A,B at the opposite longitudinal edges of the sheet 153, which are open slots. Of course, slot size width, length and location will vary with the engineering, functional and performance requirements of the seal, and appropriate variations will be made by a person skilled in the art in dependence on the circumstances.

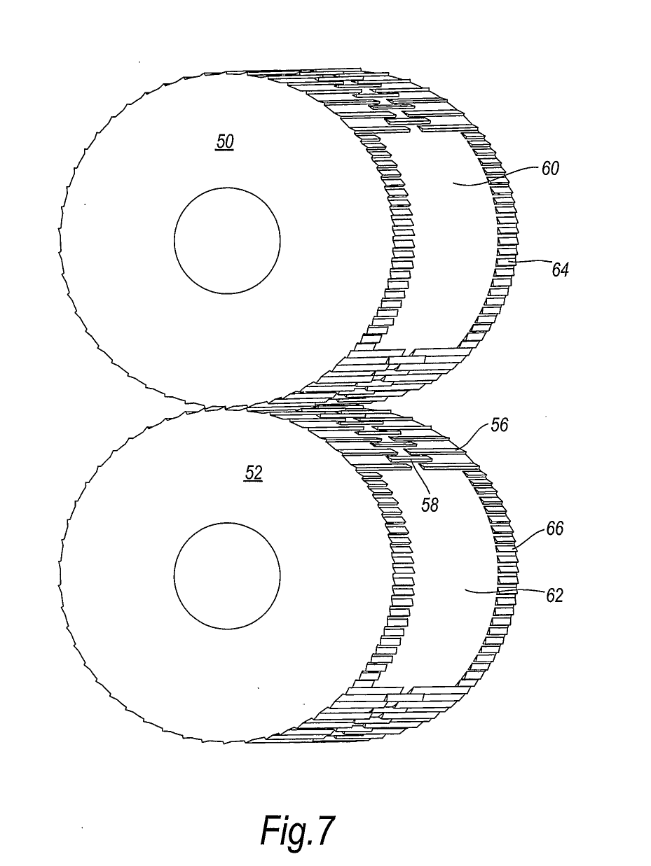

The carrier 117 may be formed by a lance and stretch, a lance and coin or a stamping operation. The carrier 117 may be formed by the apparatus and method described above in relation to FIGS. 1 to 12, with appropriate modifications to the rollers 50,52 to form the slits in the desired locations.

The edge slots 164A of the side wall 139 of the flange receiving channel 115 terminate approximately three quarters of the distance up the side wall 139. A respective long slot 162A is formed between (and staggered from) each pair of edge slots 164A, each long slot 162A commencing about mid-way up the side wall 139 and extending into the base 137, where it terminates. A second series of slots 162B, staggered from the first series 162A (and aligned with edge slots 164A) starts in the base 137 and extends approximately half-way along the side wall 121. A third set of slots 162C, staggered from the series 162B but aligned with the series 162A extend approximately along three quarters of the length of the side wall 121 and into the base 123 of the window pane receiving channel 113. A fourth series of slots 162D, staggered from the series 162C but aligned with the series 162B (and the edge slots 164A), extend along the base 123, including the “Roll Form” feature 152). A fifth series of slots 162E, staggered from the slots 162D but aligned with the slots 162C and 162A, commences in the base 123 and terminates approximately a quarter of the length of the outer side wall 119 of the window pane receiving channel 113. Shorter slots 160 (staggered from slots 162E but aligned with slot 162D and 162B) extend approximately three quarters of the length along the side wall 119.

Each aligned edge slot 164A, longer slots 164B, 164D and shorter slot 160 has a similar orientation. Staggered from these slots are aligned longer slots 162A,162C and 162E, and shorter slot 164A. Those slots have the same orientation as one another and are oppositely oriented with respect to the slots from which they are staggered.

It will be apparent that the form of the carrier 117 illustrated is such that, although the slots formed through each of the side walls 119,121 and 139 are configured similarly, the slots in one side wall are offset in relation to those of the adjacent side wall. When the strip, with the carrier embedded within it, is bent to form a curve or corner, such bending will be resisted by the asymmetric arrangement of the slots in adjacent side walls. A certain amount of strain is created in the material of the carrier 117 when bending occurs. The strain has the effect of making the carrier 117 semi-rigid in form. In other words, although it may be bent to follow curves or corners, once bent it generally retains its bent shape. It is thus able to preserve a predetermined configuration.

At the position of the 90° corner of the strip (point M in FIG. 13,19) in use, and at the 45° corner of the strip (point L in FIG. 13,19) in use, the carrier 117, when embedded in the seal 101, is “stretch bent” into position and shape. This provides the strip with relatively high rigidity in these areas (simulating a localised rigid carrier or core section—as if the carrier was solid and did not have slots in this region). The seal in its virgin state is encased in a series of rolls and mandrels while clamped on the outer extremities (later removed). The seal is mechanically stretched to a predetermined amount while the extremities of the seal are moved inward around points M and L. Points M and L are encased in a series of rolls and mandrels to maintain cross-sectional shape while the mechanical movement of the bending machine forms the corner at points M and L. Through the process of stretching and bending, slight deformations occur at points 162 A . . . E. These deformations remain permanent in the imbedded carrier allowing the bent shape to remain. The amount of deformation is determined by the amount of stretch applied to the product.

The region O (FIG. 19) of the strip 101 between the stretch bent corner regions L,M is relatively less rigid and is relatively easily compressible and/or extendible.

The different rigidities of the strip 101 at the regions O and L,M allows the strip 101 to be supplied with the required relatively rigid corner regions L,M. The flexible region O therebetween allows dimensional variations between respective door frames 103 to be accommodated by the strip 101. Such variations in the frame 103 may occur due to tooling variations or sourcing of the frame 103 (and the associated door 105) from different suppliers.

As an alternative to varying the rigidity by “stretch bending”, rigidity could be varied by forming slitted areas (of particular configuration) and non-slitted areas using the method and apparatus described with reference to FIGS. 1 to 12.

For example, the method and apparatus of FIGS. 1 to 12 may form the carrier with a pattern of slits to provide higher rigidity at the corners M and L. The carrier may be unslitted at these corners, or may have a pattern of slits and a shape that makes the carrier relatively rigid at the corners.

In prior art sealing strip arrangements having a slotted carrier embedded therein, the presence of the slotted carrier embedded within the sealing strip is sometimes apparent from the exterior of the sealing strip 101 due to a series of indentations corresponding to the slots being visible in the strip 101—sometimes referred to as “carrier read-through”). In the embodiment a special tooling technology is used to avoid carrier read-through. The slotted openings in the carrier creates volume difference when a constant volume of the base material—the flexible material forming the strips—(EPDM, TPE'S, TPO's) are applied. This constant volume of base material when interacting with the varying volume of the carrier corresponds to “carrier read-through”. This phenomenon is corrected in the tooling by heat fusing individual layers of the base material. Layering the material provides constant volume adjustment of the material being applied.

1. A sealing, trimming or guiding strip for sealing around an opening in a frame, the strip comprising flexible material and having a reinforcing member at least partially embedded in the flexible material, the member having a series of apertures formed therein and being arranged such that the rigidity of the member can be selectively varied at respective parts of the strip.

2. The strip of claim 1, wherein the opening of the frame is closed by a closure member.

3. The strip of claim 2, wherein the closure member comprises a window pane.

4. The strip of claim 2, including a closure member channel along which the closure member slides, the closure member channel having a higher rigidity than other parts of the strip.

5. The strip of claim 1, wherein the frame includes at least one corner and the strip has a higher rigidity at the corner than at other parts of the strip.

6. The strip of claim 5, wherein the member is stretch bent at said corner.

7. The strip of claim 1, including a flange channel for grippingly receiving a flange of said frame for securing the strip to the frame.

8. The strip of claim 1, including at least one part of relatively low rigidity that is relatively easily stretched and/or compressed for accommodating variations in dimensions of the frame.

9. The strip of claim 2, wherein the closure member channel and the flange channel extend in generally opposite directions.

10. The strip of claim 1, comprising thermoplastic olefin material (TPO).

11. The strip of claim 10, wherein the TPO is provided in an outer layer of said strip.

12. The strip of claim 10, wherein the TPO is coloured.

13. The strip of claim 1, wherein the reinforcing member is formed by a lance and stretch operation.

14. The strip of claim 1, wherein the reinforcing member is formed by a lance and coin operation.

15. The strip of claim 1, wherein the reinforcing member is formed by a stamping operation.

16. The strip of claim 1, wherein the flexible material of the strip is formed by extrusion.

17. The strip of claim 16, wherein the reinforcing member is at least partially embedded within the flexible material during the extrusion process.

18. The strip of claim 4 or 7, wherein the closure member channel or the flange channel comprises a base from which spaced apart side walls extend, the reinforcing member in each side wall having a respective series of slots arranged side-by-side along the length of the reinforcing member, the slots being of two different types, each slot through one of the side walls being displaced along the length of the reinforcing member with respect to a respective one of the slots of the other side wall, wherein each of the two series of slots includes slots of both said types alternating with each other along the respective side wall, wherein each of the slots of one said type is a short slot open at the distal end of the respective side wall and extending in that wall from that edge to terminate in the same wall, and in that each of the slots of the other said type is a respective closed long slot extending from a point within the respective side wall to terminate at a point in the base of the channel.

19. The strip of claim 18, wherein each long slot extends approximately three quarters of the distance across the base of the channel.

20. A method of forming a sealing, trimming or guiding strip for sealing around an opening in a frame, the method including at least partially embedding a reinforcing member within flexible material forming the strip, the reinforcing member having a series of apertures formed therein, the member being arranged such that the rigidity of the member can be selectively varied at respective parts of the strip.

21. The method of claim 20, including selectively varying the rigidity of the member at respective parts of the strip.

22. Apparatus for producing a longitudinally extending reinforcement for a flexible strip, comprising a pair of rotary processing members arranged to have a bight between them, means defining a working path passing through the bight, and means for feeding a longitudinally extending blank along the path, at least a first one of the rotary members being provided with cutter means arranged around a first portion, only, of its circumference and in alignment with the said path so as to carry out cutting operations on the blank as it passes through the bight in engagement with those cutter means, there being no cutter means on the second, remaining, portion of the circumference of the first rotary member and no cutter means on a corresponding second portion of the circumference of the second rotary member, so that no cutting operations are carried out on the blank by the said second portions of the circumference of the rotary members.

23. Apparatus according to claim 22, in which the second rotary member is provided with cutter means extending over a first portion of its circumference which corresponds to the first portion of the first rotary member.

24. Apparatus according to claim 22, in which the width, measured in an axial direction, of the rotary members is greater than the width of the said path, and in which at least one of the rotary members has an outwardly projecting formation positioned outside the width of the path and extending around at least the second portion of the circumference thereof for engaging the second portion of the circumference of the other rotary member to provide a gap between the rollers at the bight thereof, the gap corresponding in width at least to the width of the said path and through which gap the blank can be freely moved longitudinally.

25. Apparatus according to claim 24, including feeding means for feeding the blank along the working path, and control means for stopping or altering the longitudinal speed of movement of the blank along the working path when the blank is in the said gap.

26. Apparatus according to claim 25, including control means for stopping or altering the speed of rotational movement of the said members when the blank is in the said gap.

27. Apparatus according to claim 25, in which the control means includes means responsive to the longitudinal position of the blank along the working path and the angular position of the rotary members.

28. Apparatus according to claim 22, in which the cutter means comprise cutter blades positioned on the said first portion of the circumference of the first or each rotary member and extending parallel to each other around that portion and in a direction axially of the member.

29. Apparatus according to claim 28, in which the cutter blades extend across part, only, of the width of the working path and thus cut only a corresponding part of the width of the blank.

30. Apparatus according to claim 29, in which the cutter blades comprise a first type of cutter blades which are sized and positioned so as to extend across a central part, only, of the width of the working path, and a second type of cutter blades which are sized and positioned to extend across part, only, of the width of the working path from a respective edge thereof.

31. Apparatus according to claim 30, in which the first and second types of cutter blades alternate around the portion of the circumference of the first or each rotary member.

32. Apparatus according to claim 28, in which the cutter blades immediately adjacent to each junction between the end of the or each first circumferential portion and the adjacent end of the or each second circumferential portion have a greater pitch than the cutter blades over the rest of the or each first circumferential portion.

33. Apparatus according to claim 28, in which the cutter blades immediately adjacent to each junction between the end of the first or each circumferential portion and the adjacent end of the or each second circumferential portion are of reduced length, measured across the width of the working path, compared with the lengths of the cutter blades in the rest of the or each first circumferential portion.

34. Apparatus according to claim 22, in which the cutter means produce slits extending through the thickness of the blank, and including stretching means for stretching the blank to convert the slits into slots.

35. Apparatus according to claim 34, in which the stretching means comprises means for applying pressure to the thickness of the blank along a longitudinal track therealong which is less than the width of the blank so as to compress the material of the blank.

36. Apparatus according to claim 22, including means for bending the blank into channel-form after it has passed through the bight of the rotary members.

37. Apparatus for producing a longitudinally extending metal carrier for a sealing, trimming or guiding strip, the carrier having longitudinally extending relatively flexible regions provided with slots therethrough and separated by longitudinally extending relatively rigid and unslotted regions, comprising: means defining a longitudinally extending working path; feeding means for feeding a longitudinally extending metal blank along the working path which has the same width as the working path; a pair of rotary cutters rotating in opposite directions in contact with each other about parallel axes extending widthwise across the said path and so that the working path passes through the bight between the two rotary cutters; the rotary cutters each having a width measured in the axial direction which is greater than the width of the said path; each rotary cutter having a first surface portion extending around part, only, of the circumference of the cutter and carrying cutter blades extending axially of the cutter and spaced apart from each other over the peripheral extent of the first portion and each cutter extending across part, only, of the width of the working path, whereby the cutter blades cut slits through the metal blank in the working path as the cutter blades come into engagement with each other at the bight, and a second surface portion extending over the remaining circumferential part of the cutter and which is free of cutter blades so that the blank is not cut when any part of these portions are present at the bight of the cutters; stretching means for stretching the blank so as to convert the slits into slots; and means for forming the blank into channel-form.

38. Apparatus according to claim 37, including formations on the rotary cutters in the second surface portions thereof which are positioned outside the working path and projecting radially outwards of the surfaces of the cutters so as to engage each other and provide a gap between the surfaces of the cutters when the second surface means are present at the bight.

39. Apparatus according to claim 38, in which the feeding means includes control means for stopping or altering the speed of longitudinal movement of the blank when it is present in the said gap.

40. Apparatus according to claim 38, including control means for stopping or altering the rotary speed of the rotary cutters when the blank is present in the said gap.

41. Apparatus according to claim 39, in which the control means includes means responsive to the longitudinal position of the blank in the working path and the angular positions of the rotary cutters.

42. Apparatus according to claim 37, in which the cutter blades immediately adjacent to each junction between the end of each first circumferential portion and the adjacent end of each second circumferential portion have a greater pitch than the cutter blades over the rest of the or each first circumferential portion.

43. Apparatus according to claim 37, in which the cutter blades immediately adjacent to each junction between the end of each first circumferential portion and the adjacent end of each second circumferential portion are of reduced length, measured across the width of the working path, compared with the lengths of the cutter blades in the rest of each first circumferential portion.

44. A method of producing a reinforcement which is for incorporation in a flexible strip and which has longitudinally alternating relatively flexible and relatively stiff regions, comprising the steps: of feeding a longitudinal blank along a working path which has the same width as the blank and which passes through the bight of two rotary cutter members which have cutter blades positioned at predetermined intervals spaced from each other around a first surface portion, only, of the circumference of each rotary cutter such that the cutter blades when present at the bight produce cuts through the blank but extending only partway across the width thereof, whereby to produce a said relatively flexible region of the reinforcement; each rotary cutter being free of any cutter blades over a second surface portion corresponding to the remaining circumferential part of the cutter so that no cuts are produced in the blank when the second portions are present at the bight, whereby to produce a said relatively stiff region of the blank; and adjusting the position of the blank in relation to the angular positions of the rotary cutters so as to adjust the length of the said relatively stiff region of the blank.

45. A method according to claim 44, in which the adjusting step comprises the step of changing the speed of feeding of the blank along the working path.

46. A method according to claim 44, in which the adjusting step comprises the step of stopping or altering the speed of rotation of the rotary cutters.

47. A method according to claim 44, including the step of stretching the blank at least over the relatively flexible regions thereof, so as to convert the cuts into slots.

48. A method according to claim 47, in which the stretching step comprises the step of compressing the thickness of the blank along a predetermined path thereon which extends over less than the width of the blank and runs at least along the relatively flexible regions thereof.

49. A method according to claim 44, including the step of bending the blank into channel-form.

50. A method according to claim 44, including the step of extruding flexible material over the blank at least after the steps of producing the relatively flexible and stiff regions thereon.
